(19) United States
(12) Patent Application Publication
(10) Pub. No.: US 2016/0372225 A1
(43) Pub. Date: Dec. 22, 2016

(54) WASTE CONTAINER FOR COLLECTING HAZARDOUS MATERIAL

(71) Applicant: Pentek, Inc., Coraopolis, PA (US)

(72) Inventors: Sheldon Lefkowitz, Sewickley, PA (US); Anton Galkin, Pittsburgh, PA (US)

(73) Assignee: Pentek, Inc., Coraopolis, PA (US)

(21) Appl. No.: 13/895,352

(22) Filed: May 15, 2013

Related U.S. Application Data
(60) Provisional application No. 61/647,486, filed on May 15, 2012.

(51) Int. Cl. G21F 9/36; B65D 90/28; B65D 90/34; B65D 90/48; B65D 88/54; G21F 9/20; B01D 46/00; B01D 46/46; B01D 46/42; B01D 46/44; G21F 5/005; G21F 5/002; B65D 90/26; B65D 90/16

(52) U.S. Cl. CPC G21F 9/36; B65D 90/26; B65D 90/28; B65D 90/34; B65D 90/48; B65D 88/548; B65D 90/16; B01D 46/0068; B01D 46/46; B01D 46/4254; B01D 46/446; B01D 46/0084; G21F 5/005; G21F 5/002; G21F 9/20; B01D 2273/10; B01D 2273/28; G21Y 2002/501; G21Y 2004/601; G21Y 2004/501

(57) ABSTRACT

A container is provided for collecting and filtering material. The container includes an inlet penetration through at least one surface of the container, and an outlet penetration through at least one surface of the container. The container further includes at least one filter being integral to the container such that the at least one filter is disposed of together with the container. The at least one filter is connected to the outlet. The material enters the container through the inlet, the material conveyed by a media (filtrate) is passed through the at least one filter resulting in a clean media stream (permeate), and the clean media exits the container through the outlet.

### I. CROSS-REFERENCE TO RELATED APPLICATION

This application claims the benefit of U.S. Provisional Patent Application No. 61/647,486, filed May 15, 2012, the contents of which are hereby incorporated by reference as if fully stated herein.

### II. FIELD

Example aspects described herein generally relate to a container for collecting and storing hazardous material, and more particularly, to a container for collecting, filtering and storing of hazardous material for disposal.

### III. BACKGROUND

When cleaning up hazardous waste from a hazardous spill, one concern is to clean up or collect the spill with little exposure to the people performing the clean-up. More specifically, for nuclear power plant accidents, there is a particular concern with radioactive material.

Conventionally, the hazardous waste is vacuumed into a container using air as a medium. During this procedure, the hazardous materials, which are, for example, dried solid material, are often very dusty, such that the dust often becomes airborne and difficult to control. To address the foregoing, a filtered vacuum source, typically provided outside of the container, is used with the vacuum to prevent or hold back contaminants from being re-introduced into the air.

In these situations, when the container becomes full, the full container is typically replaced with an empty container. In addition, the filters used with the vacuum eventually need maintenance or need to be replaced. Accordingly, personnel, adjacent equipment, tools, and the environment are potentially exposed to harmful materials during these activities. In addition, these activities generate additional waste materials, thus increasing the magnitude of the hazardous waste that must be managed.

### BRIEF DESCRIPTION

The example embodiments described herein address the above-identified concerns by providing a container for vacuum collecting and packaging hazardous material for disposal. The container includes an inlet penetration through at least one surface of the container, and an outlet penetration through at least one surface of the container. In addition, the container includes at least one filter being integral to the container such that the at least one filter is disposed of together with the container, the at least one filter being connected to the outlet. The hazardous material enters the container through the inlet, the hazardous material conveyed by a media is passed through the at least one filter resulting in a clean media stream, and the clean media exits the container through the outlet.

The term hazardous material is not limited in meaning by definitions contained in environmental regulations, but is used broadly to include any material, in any state (e.g., solids, liquids, or gases) that must be safely managed to avoid harm to people, other living organisms, property or the environment. As one example, hazardous material can include radioactive waste which contains radioactive material as a by-product of nuclear power generation or nuclear spillage. This radioactive waste can be dry, having a hazardous dust residue. Alternatively, the radioactive waste can be liquid, wet, or saturated with water.

In view of the hazardous material being collected, the container is provided so as to collect the vacuumed material with minimal human contact/interaction or without close proximity to the site containing the hazardous material. In this regard, the container can be remotely operated so that human contact with the container is minimized during the collection of the hazardous material.

For example, all operations of the container can be performed via remote control. These operations include connection of hoses to the container, disconnection of hoses to the container, sealing the connection openings, and lifting and/or handling of the containers whether empty or full. Moreover, the container is delivered to the site containing hazardous material by flying in the container, for example, using a crane and hook, or a remotely operated or shielded fork truck. This fly-in delivery method of the container, together with the remote control of the operations of the container advantageously allows operators to be, for example, at least 1,500 meters away from the site containing the hazardous material during the collection process.

As for the structure, the container can be any shape and size, and can be made of any materials appropriate for handling the hazardous material. The container includes a self-cleaning filter mechanism positioned inside the container. The self-cleaning filter mechanism allows filtration to be performed inside the container until the box is full of hazardous material. In this regard, whether the container is full is determined based on one or more factors. These factors include, for example, weight, volume, radioactive dose rate, specific concentration of waste, or any other number of performance parameters, which will be described in more detail below.

The container is also structured to meet strict regulatory standards for safe handling, highway transport (e.g., on public roads) and long-term storage, for example, in a marine environment while plans are developed for ultimate disposal of the container.

In that regard, filter cartridges (or filter media) included in the self-cleaning filter mechanism of the container will be stored and ultimately disposed of with the container. For example, the self-cleaning filters may never be maintained or replaced during or after collecting the hazardous material. By storing or ultimately disposing the self-cleaning filter mechanism with the container storing the hazardous material, it is possible to (1) eliminate adverse exposure to the hazardous material, and (2) eliminate the need to independently handle and process any filter elements for separate disposal.

### BRIEF DESCRIPTION OF THE DRAWINGS

The features and advantages of the example embodiments of the invention presented herein will become more apparent from the detailed description set forth below when taken in conjunction with the following drawings.

FIG. 1 is an isometric view illustrating a container for collecting and filtering hazardous waste, in which the inside of the container is exposed, according to an example embodiment.

FIGS. 2 and 3 are isometric views illustrating the container shown in FIG. 1.

FIG. 4 is a side view illustrating the container shown in FIG. 1.

FIG. 5 is an isometric view illustrating a skid structure including the container shown in FIGS. 1 to 4, according to an example embodiment.

FIG. 6 is a top view and a side view illustrating a lower portion of the skid structure shown in FIG. 5, according to an example embodiment.

FIG. 7 is an isometric view illustrating a mechanism for moving a vacuum tube for insertion into a container according to an example embodiment.

FIG. 8 is an axial side view illustrating the mechanism shown in FIG. 7.

FIGS. 9 and 10 are isometric views illustrating the mechanism shown in FIG. 7 together with additional structure according to an example embodiment.

FIG. 11 is a top view illustrating the mechanism shown in FIG. 7 for illustrating insertion of the vacuum tube into the container according to an example embodiment.

FIG. 12 is a side view illustrating the mechanism shown in FIG. 7 provided for illustrating insertion of the vacuum tube into the container according to an example embodiment.

FIG. 13A illustrates four views of an entry valve for the container shown in FIGS. 1 to 4, in which the valve is open according to an example embodiment.

FIG. 13B is a view illustrating the entry valve shown in FIG. 13A, in which a vacuum tube has entered the entry valve according to an example embodiment.

FIG. 14 is a side view illustrating the container shown in FIGS. 1 to 4, illustrating how the container fits into the skid structure shown in FIGS. 5 and 6 according to an example embodiment.

FIG. 15 is an isometric view illustrating a cut-out of the lower portion of the skid structure shown in FIG. 6 according to an example embodiment.

FIG. 16 is a plan view illustrating a load cell arrangement included in the lower portion of the skid structure shown in FIGS. 5 and 6.

FIG. 17 is an isometric view illustrating a cut-out of the lower portion of the skid structure shown in FIG. 6, including a container plate according to an example embodiment.

FIG. 18 is a plan view illustrating the container plate shown in FIG. 17 according to an example embodiment.

FIG. 19 is a side view for illustrating insertion of the container shown in FIGS. 1 to 4 into the skid structure shown in FIGS. 5 and 6 according to an example embodiment.

FIG. 20 is a plan view illustrating a container base according to an example embodiment.

FIG. 21 is a graph showing insertion force of the vacuum tube versus tube insertion distance of the vacuum tube.

FIG. 22 is a diagram for illustrating a detailed cam profile of the chamfer manufactured into the piercing end of the vacuum tube.

### DETAILED DESCRIPTION

The example embodiments of the invention presented herein are directed to an integrated system for collecting, filtering and storing of hazardous material for disposal, which are now described herein in terms of an example waste container and skid structure. This description is not intended to limit the application of the example embodiments presented herein. In fact, after reading the following description, it will be apparent to one skilled in the relevant art(s) how to implement the following example embodiments in alternative embodiments.

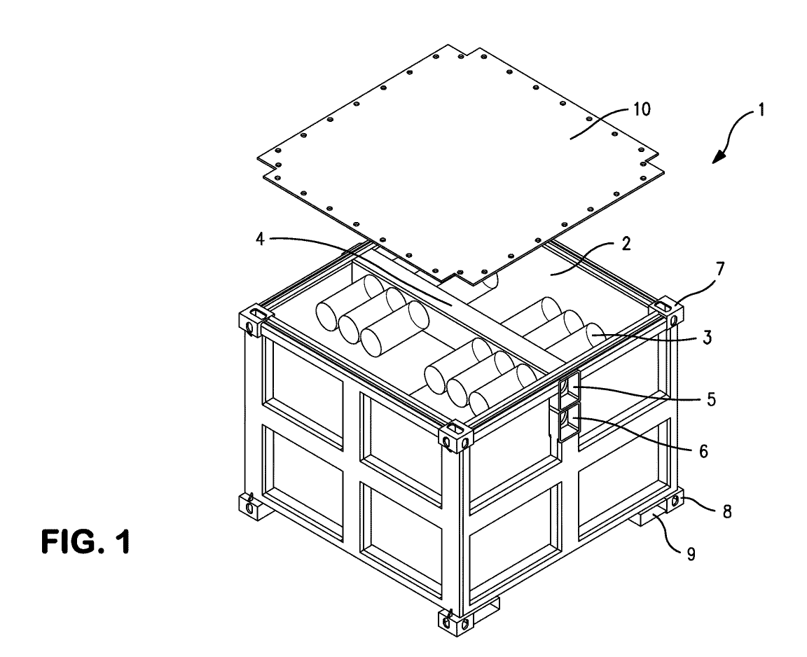

FIG. 1 is an isometric view of a container for collecting and filtering hazardous waste from a clean-up site, in which the inside of the container is exposed, according to an example embodiment. As shown in FIG. 1, a container 1 is in the shape of a box. Alternatively, in other embodiments, the container can have other shapes such as a cylinder, a sphere, a cone, etc. In this example embodiment, the size of the container 1 is roughly six (6) cubic meters. However, in other example embodiments, the size of the container can vary depending on the performance parameters, for example, parameters demanded by the clean-up site containing hazardous material. As an extreme example, the container can be the size of a building.

As shown in FIG. 1, the container 1 includes a filtering mechanism 2, at least two (2) holes, namely outlet 5 and inlet 6, four (4) top corners 7, four (4) bottom corners 8, lift slots 9, and a lid 10. The filtering mechanism 2 is positioned inside of the container 1, and is connected to the outlet 5. Outlet 5 is located on one side of the container 1. Inlet 6 is located on the same side as outlet 5, and is positioned closely adjacent to inlet 6.

In this example embodiment, two holes/ports are provided in the container. However, in other example embodiments, the container can include more than two holes/ports. For example, the container can include multiple ports on multiple sides of the container to accommodate the user's particular needs.

In yet another example embodiment, the container can include a single hole/port. For this example embodiment, baffling is provided in the container to direct both the inflow of material and the outflow of material. A bifurcated pipe being connected to the single port is then used to provide both a vacuum suction and a vacuum source, which are described in more detail below in connection with the example embodiment shown in FIG. 1.

In FIG. 1, the filtering mechanism 2 includes at least one filter 3, a plenum 4 (that can also serve as a structural element to stiffen/reinforce the container against vacuum induced stresses), and a self-cleaning mechanism (not shown). The plenum 4 is connected to the outlet 5, and the at least one filter 3 is connected externally to the plenum 4. In other example embodiments, the filter can be a filter media placed inside the plenum. While one filter is sufficient for filtering the hazardous material inside the container, in other example embodiments, the filtering mechanism can include more than one filter depending on the performance parameters required by the clean-up site. For example, twelve (12) filters 3 are shown attached to the plenum 4 in FIG. 1. The filters should provide high quality filtration of the hazardous material. In other words, the filters are, for example, suitable filters for separation of the hazardous materials being collected.

Each of the filters included in the container can be a same type of filter. Alternatively, each of the filters can be a different type of filter. For example, the container can include one or more HEPA filters, carbon filters, or other media, pumps, etc., to filter the hazardous material.

In other example embodiments, there can be multiple containers connected in series or in parallel or both via hoses and ports. The multiple containers can be stackable. Each of the multiple containers can include the same filter or media, or can include different filter or media to provide different treatment techniques in each of the different containers.

In this example embodiment, the plenum 4 extends from one inside surface of the container 1 at the outlet 5 to an opposite inside surface of the container 1. The plenum 4 is hollow so as to allow passage of air therethrough, the air exiting the container through outlet 5. Thus, the plenum provides a built-in filtration system that is intended to permanently stay inside the container. In other embodiments, the filter or filters may be connected directly to the outlet 5 without use of a plenum.

In other example embodiments, the plenum can be integrated (e.g., by welding) with the lid. Thus, the lid can be either removable or nonremovable. In the case where the lid is removable, the lid, including the plenum and the at least one filter, can be placed on and taken off of the container simply, thus providing an easier manufacturing process of the container. The plenum can be positioned on the lid such that it serves as a structural element to stiffen/reinforce the container against vacuum induced stresses, when the lid is placed on the container.

The four (4) top corners 7 and the four (4) bottom corners 8 may meet International Organization for Standardization (ISO) standards. These corners enable the container to securely fit onto intermodal transport for conveyance, similar to conventional cargo containers, for example, when transporting from a truck to a train to a boat. The four (4) top corners 7 are used to lift or pick up the container 1 using machinery, for example, a crane and a hook with a spreader. The four (4) bottom corners 8 are used to lock down the container. For example, the four (4) bottom corners can be used to lock down the container on a surface such as the roof of a building at the clean-up site or during transport. Locking down the container can help keep the container in place and secure, especially in geographic locations susceptible, for example, to seismic activity. The lift slots 9 are used to securely lift the container during, for example, transportation of the container.

Outlet 5 provides a passage from outside of the container 1 to inside of the container 1. This passage is provided to allow air to be sucked from the container 1. The suction of air is performed by connecting a vacuum (not shown), on the outside of the container 1, to the outlet 5 by way of a vacuum hose (not shown), thus creating suction on the container during evacuation of material. The vacuum includes a vacuum motor (not shown). In this example embodiment, the vacuum motor is provided external to the container. However, in other example embodiments, the vacuum motor can be provided internal to or inside the container. The outlet 5 includes a mating flange to connect and disconnect with another mating flange included on a mechanical rack, which is described in more detail below.

Inlet 6 also provides a passage from the outside to the inside of the container 1. This passage is provided to allow air to be sucked into the container 1, which creates a vacuum source. The hazardous material enters the container by way of the inlet 6, using, for example, a hose connected to the inlet 6. The inlet 6 includes a mating flange to connect and disconnect with another mating flange included on the mechanical rack, which is described in more detail below.

In this example embodiment, a vacuum source is created in order to fill the waste container 1 with hazardous material. However, in other example embodiments, the waste container can be filled by pressurizing the container by blowing into the inlet of the container, and the exhaust leaving the outlet of the container can be filtered.

The self-cleaning mechanism is provided to keep the filter or filters from becoming clogged with particulate material. According to this example embodiment, the self-cleaning mechanism uses compressed air to blow into the at least one filter 3. The compressed air is blown from the side of the at least one filter 3 closest to the outlet 5 (e.g., clean, or permeate side) to the filter's opposite end (e.g., dirty, or filtrate side) (i.e., the compressed air is blown from the clean side of the filter to the dirty side of the filter). This is referred to as pulse back with air, or backwashing the filters. Each self-cleaning using a pulse of air occurs periodically. For example, the pulse of air could occur every 30 seconds, 1 minute, or 1.5 minutes, etc. In one example embodiment, for multiple filters (i.e., at least 2), the periodic pulse of air is provided to each filter individually in a sequential rotation (e.g., a round-robin fashion). In other words, in this example embodiment, one filter is cleaned by a pulse of air while the other filter is running, and then the other filter is cleaned by a pulse of air while the one filter is running, and so on. On the other hand, for one filter, it is noted that the pulse of compressed air for cleaning the filters does not provide enough pressure to create a complete reversal of vacuum flow (e.g., blowing out incoming material).

In one example embodiment, a source for the compressed air can be located outside of the container. In other example embodiments, the source for the compressed air can be located inside of the container, where the source air is drawn from the clean side of the plenum. A power source for powering pumping of the source air can be, for example, located outside of the container. In some example embodiments, the power source can be a solar power unit mounted on the lid of the container. The compressed air can be directed from the source to a control system, for example, using tubes/pipes, where the compressed air is metered to each filter in rotation by a sequence of diaphragm valves.

In other example embodiments, the filters can be self-cleaned, for instance, by shaking the filters using mechanical agitation, or by reverse flushing the filters in the case that the material is a fluid.

By virtue of the self-cleaning mechanism, it is possible to fill the container with hazardous material until the container becomes full, without having to change or service the filters by any means whatsoever.

During evacuation of the clean-up site, the container is continuously filled with material indefinitely, or until the container is filled up. The container is considered full, or filling of the container is considered complete, due to a number of factors. These factors include, for example, (1) volume of material in the container, (2) weight limitations of the container, (3) concentration level of radioactive/hazardous material (i.e., “too hot to handle”), (4) industry standards of certain concentrations (e.g., only certain levels of cesium 137 and uranium 235 allowed to be collected), (5) burial limits on waste (e.g., criticality limits or situations that could create undesirable reactions).

In this example embodiment, the container 1 includes mechanisms/instruments to detect when the container 1 is full. One example mechanism is a weight alarm that measures the weight of the container. The weight alarm requests for the vacuuming to be stopped when the container reaches a predetermined weight. The predetermined weight is determined based on, for example, weight limitations set forth by the machinery being used to transport the containers. Another example mechanism is an internal level indicator which measures/detects a filled volume of the container. The internal level indicator requests for the vacuuming to be stopped when the material reaches a predetermined height within the container. The predetermined height can be, for example, a height of the material within the container, at which the material interferes with the filtration mechanism. Yet another example mechanism is a chemical sensor which detects concentrations of certain chemicals. The chemical sensor requests for the vacuuming to be stopped when a predetermined concentration of a certain chemical has been reached. The predetermined concentration can be based on, for example, industry standards. Each of the mechanisms can use, for example, radio frequencies to send the requests for stopping the vacuum. This enables the operation of filling the container with hazardous material to be automatic and remotely controlled. These signals could also be sent to an external control system via porting the circuit thru wire or fibre optic conductors thru a remotely operable bulkhead connector.

In other example embodiments, the filtering mechanism can include a differential pressure gage to detect a pressure differential across the filter(s) when the filter(s) become clogged, for example. By providing the differential pressure gage, it is possible to detect when the pressure on the filter(s) rises to a level that may collapse the filter(s).

In another example embodiment, the container can include a differential pressure gage to detect a pressure difference between the inside and the outside of the container. This differential pressure gage enables detection of when the pressure outside the container is greater than the pressure inside of the container. By providing this detection, it is possible to detect a scenario where the container may collapse itself.

Conventionally, when the container is determined to be full, the filter is removed. However, in the present disclosure, the filtering mechanism 2 including the at least one filter 3 is thrown away or disposed of with the container.

After the container is determined to be full, the container 1 is sealed at the outlet 5 and the inlet 6. When sealing the container, the filling up of the container 1 is maintained up until removal of the vacuum connections. In particular, the container 1 is separated from the vacuum source (e.g., hoses being used to fill up the container). The container is positioned in a mechanical rack and stored away in a controlled area. More specifically, when connecting vacuum hoses and disconnecting vacuum hoses to the container 1, the mechanical rack is positioned adjacent to the container 1. The hoses are then connected and disconnected from the container 1 using a machine to join and disjoin the mating flanges provided on the mechanical rack and the outlet 5 and inlet 6. All operations of the mechanical rack and the machine can be remotely controlled using, for example, radio frequency communications. Alternatively, each of the operations can be performed manually.

When disconnecting the hoses, the inlet 6, being the dirty/contaminated hole, is disconnected first and capped and sealed. Then, the outlet hole 5, which is protected by the filtering mechanism 2, is disconnected and capped and sealed. When disconnecting the hoses, atmosphere rushes into the container through a small seam at high speed. This flow creates a fresh air curtain to keep any radioactive or other hazardous material inside the container. As a result, hoses can be connected and disconnected from the container in, for example, a dustless manner.

In one example embodiment, the container is intended to be used, for example, near or on the coast, in a marine environment. In this regard, the container can be constructed of stainless steel, or a carbon steel container may be coated on its outside surface with a coating material that prevents or inhibits corrosion. In addition, the hazardous material may be assumed to be stored in the container indefinitely. In view of the foregoing, the inside surface of the container is coated with a material to address chemical combinations reacting over time which produce, for example, hazardous byproducts (e.g., hydrogen gas). Also included in the container is a vent which prevents hazardous material from being released, but allows for a pressure release of gas buildup within the container. The vent can include, for example, a HEPA filter to help prevent hazardous material from being released. The vent can be, for example, a NucFil® vent. The vent will help manage hydrogen accumulation due to hydrolysis of latent moisture and condensation, thus mitigating against the possibility of an explosion.

In other example embodiments, the container can include a drain to release any buildup of water or other fluids in the container.

In another example embodiment, the container can include inspection ports for inspecting inside of the container. The inspection ports may make use of a number of different mechanisms to measure/detect the conditions inside the container. For example, cameras and lights can be provided in the inspection ports. A video signal from the camera can be transmitted via WIFI to an offsite control station. In another example, a device such as a smart phone, for example, an iPhone® can be placed inside the container. Using its built-in features of a camera and video recorder with flash, an accelerometer, etc., the device can send certain characteristics of the container to a control station via WiFi or another wireless communication network.

Thus, the foregoing monitoring mechanisms can provide status of the container using sampling ports. The monitoring mechanisms can provide local or remote monitoring, including power, communications and recording means. The monitoring can be performed in real time or periodically.

In some example embodiments, heating and air circulation can be provided inside of the container to dry out excess moisture in the container.

After the container or containers have been filled with the hazardous material, concrete or another long term solidification material can be pumped into the container to fill in any gaps within the material stored in the container. This will provide the container(s) with better structural integrity when being stored, for example, underground. The concrete or other material can be pumped into the container through one or more of the ports.

In some example embodiments, the containers can include RFID tags, etc., for keeping track of the containers throughout the cleaning process and during filling, handling, storage and transportation of the containers.

Each of the mechanisms or processes regarding operation of the container as discussed above can be remotely performed. Thus, the container can be remotely placeable, operable and removeable. On the other hand, in other instances, each of the mechanisms or processes regarding operation of the container can be performed manually.

In some example embodiments, the container can be emptied by, for example, port or an open lid (e.g., large port) so that the contents of the container may be further processed or so that the container can be reused, decontaminated and dispositioned. The container can be reused, for example, at another location, recycled, or recharged with changeable media, with the used media being disposable.

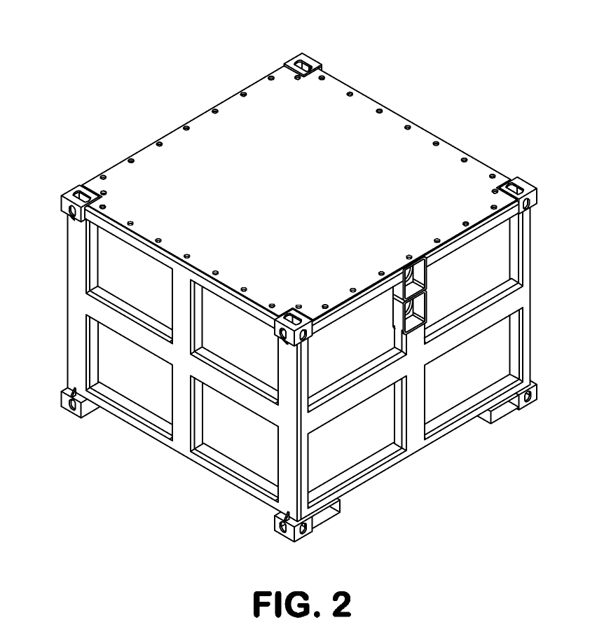

FIG. 2 shows the container 1 in which the lid 10 has been sealed according to an example embodiment.

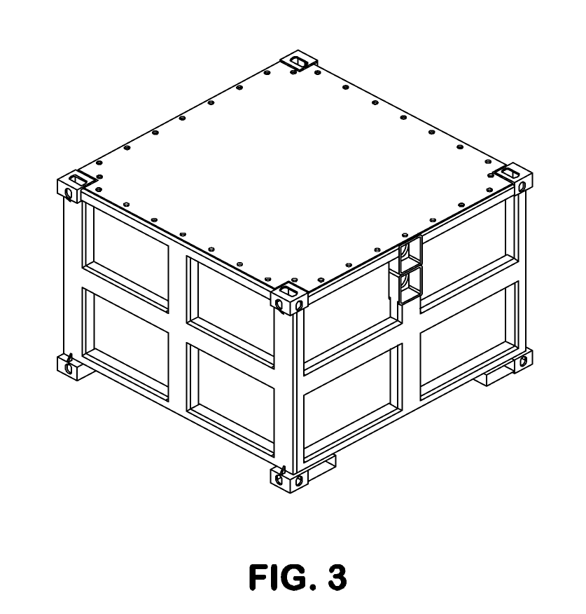

FIG. 3 shows the container 1 in which the outer surface has been coated with a corrosion preventative material according to an example embodiment.

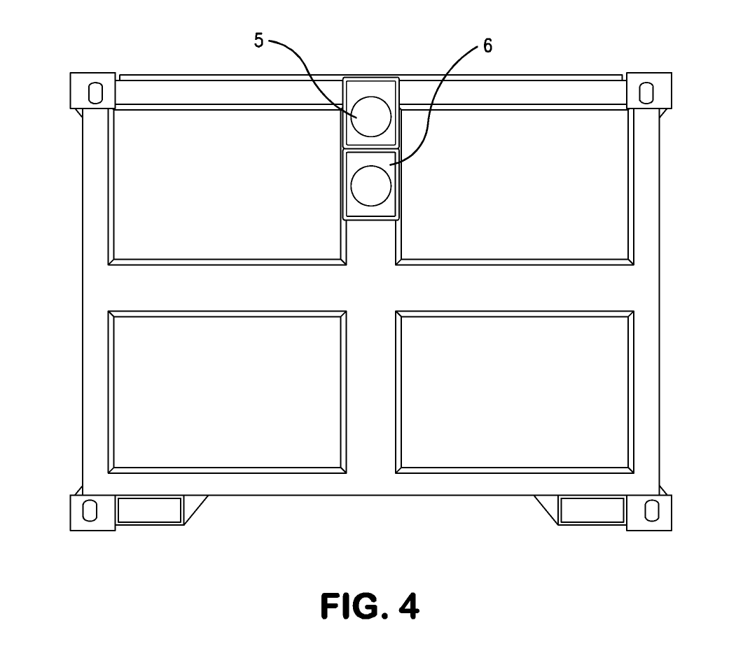

FIG. 4 shows a side view of the container 1 in accordance with an example embodiment. As shown in FIG. 4, outlet 5 and inlet 6 are positioned on a side of the container near the top surface of the container.

In one example embodiment, the outlet 5 can be placed above the inlet 6 so as to allow the filters to occupy the highest elevation inside the container. This provides protection against incoming material striking or damaging the filters, and also allows the fill volume of the container to be maximized.

In some example embodiments, one or more baffles are provided inside of the container to protect the filters from being damaged during the filling process. In addition, one or more baffles can be provided inside the container to promote uniform filling of the container by guiding the incoming material. In another example embodiment, the container can be oriented in such a way during filling of the container so as to promote uniform filling thereof.

In an alternative example embodiment, the hazardous material can be pumped or injected into the container through one or more ports/holes in a side of the container, rather than being sucked into the container via a vacuum system.

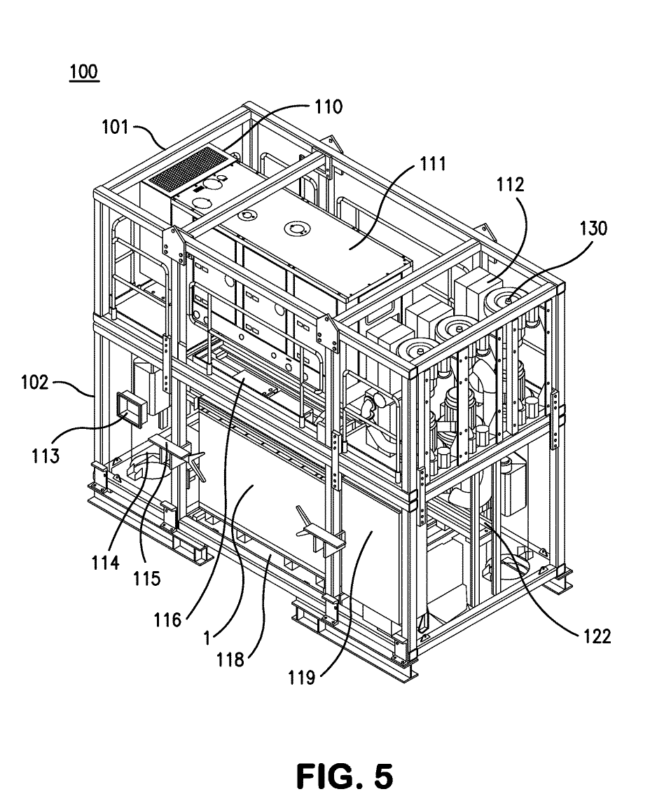

FIG. 5 is an isometric view for explaining a skid structure including the container 1 and the mechanical rack discussed in connection with FIGS. 1 to 4, according to an example embodiment. More specifically, FIG. 5 shows a skid structure 100 which is provided for transporting and enabling operation of the container 1, among other functions which will be described in more detail below. The skid structure 100 is provided with structure making it flyable. As shown in FIG. 5, the skid structure 100 includes an upper portion 101 and a lower portion 102.

The upper portion 101 includes a generator exhaust deflector 110, a generator housing 111, HEPA filters 112 and vacuum blowers 130. The generator housing includes a generator (not shown). The generator exhaust deflector 110 is provided to protect, from hot exhaust gases generated by the generator, the frame of the skid structure 100, components included in the skid structure 100, and other objects which may be positioned in the proximity of the skid structure 100. The generator housing 111 is provided to house an electric generator which provides power, for example, to the vacuum motor described above in connection with FIG. 1. The HEPA filters 112 are provided to further filter the media stream exiting the container 1. The vacuum blowers 130 are provided to create the vacuum suction described above in connection with FIG. 1.

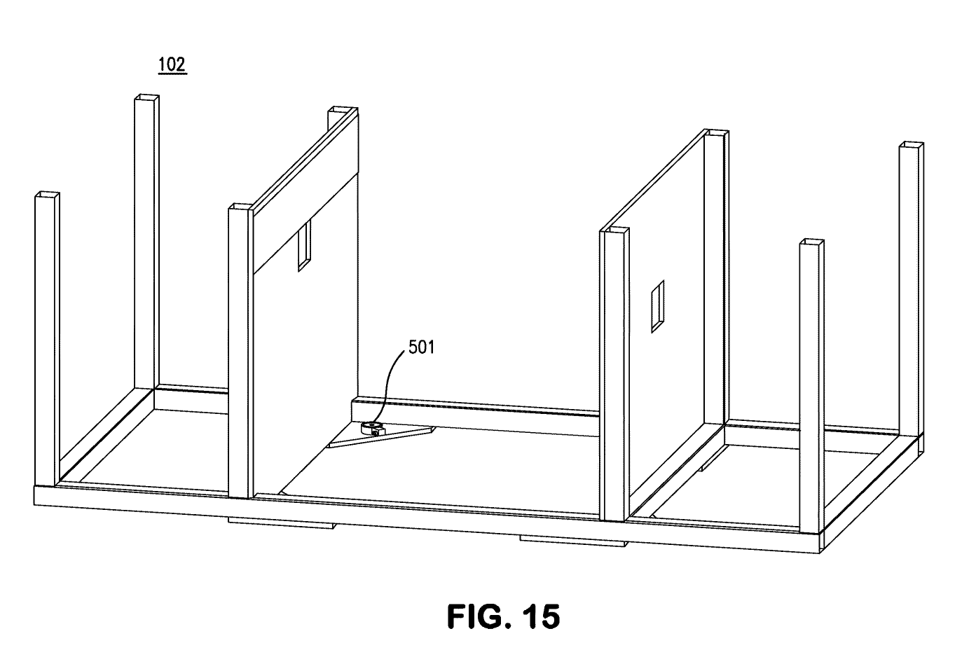

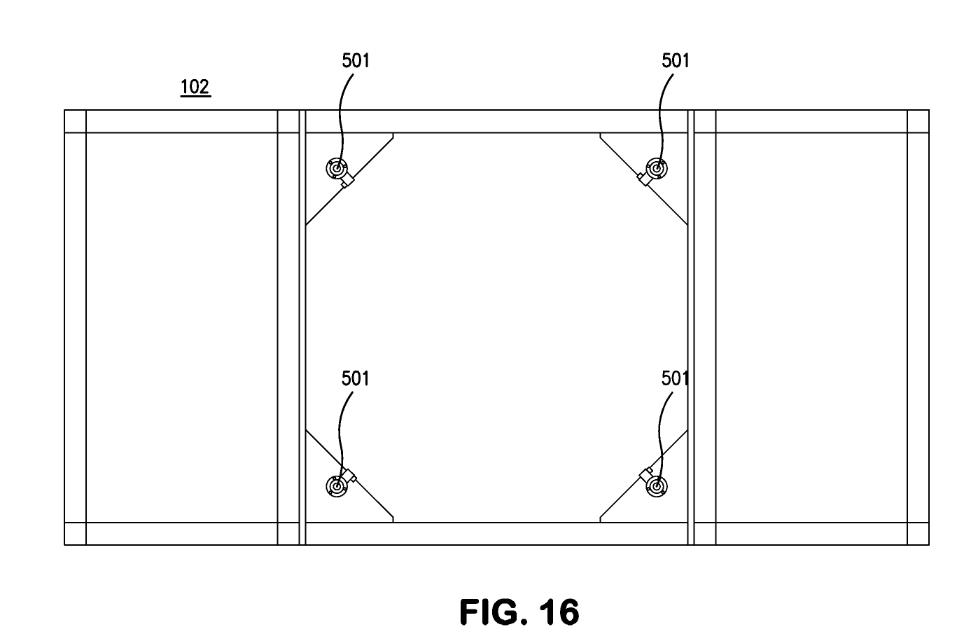

The lower portion 102 includes a radiation detector readout 113, an anchor silo/tube 114, safety bars 115, batteries 116, a load cell weighing plate 118, an electronics enclosure 119, and a vacuum tube insertion mechanism 122. The lower portion 102 further houses the waste container 1 which is removable. The radiation detector readout 113 displays a level of radiation detected inside the waste container 1. The anchor silo/tube 114 can be provided in at least two bottom corners of the skid structure 100. The anchor silo/tube includes an anchoring mechanism which stabilizes the skid structure 100 in place during operation. The safety bars 115 prevent the waste container 1 from falling out of the skid structure 100 during, for example, placement or removal of the skid structure 100. The batteries 116 can provide power to electronics provided on the skid structure 100, and can also be used as a back-up for the electric generator. The load cell weighing plate 118 provides support for the waste container 1. The load cell weighing plate is discussed in more detail below in connection with FIGS. 15 and 16. The electronics enclosure 119 includes electronic circuitry for operating, for example, each of the status monitors discussed above in connection with FIG. 1.

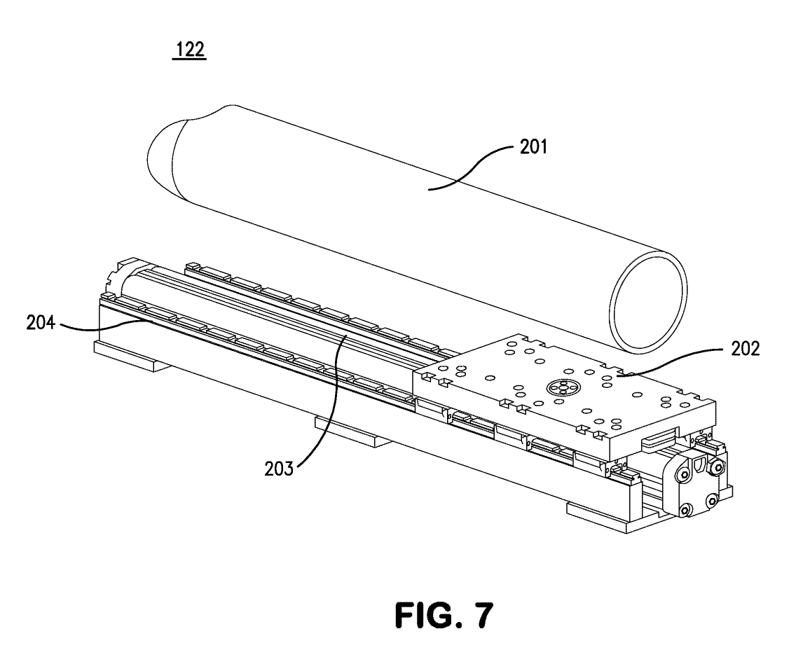

The vacuum tube insertion mechanism 122 is for inserting and withdrawing a vacuum tube into and out of the container 1 and is described in detail below in connection with FIGS. 7 to 12.

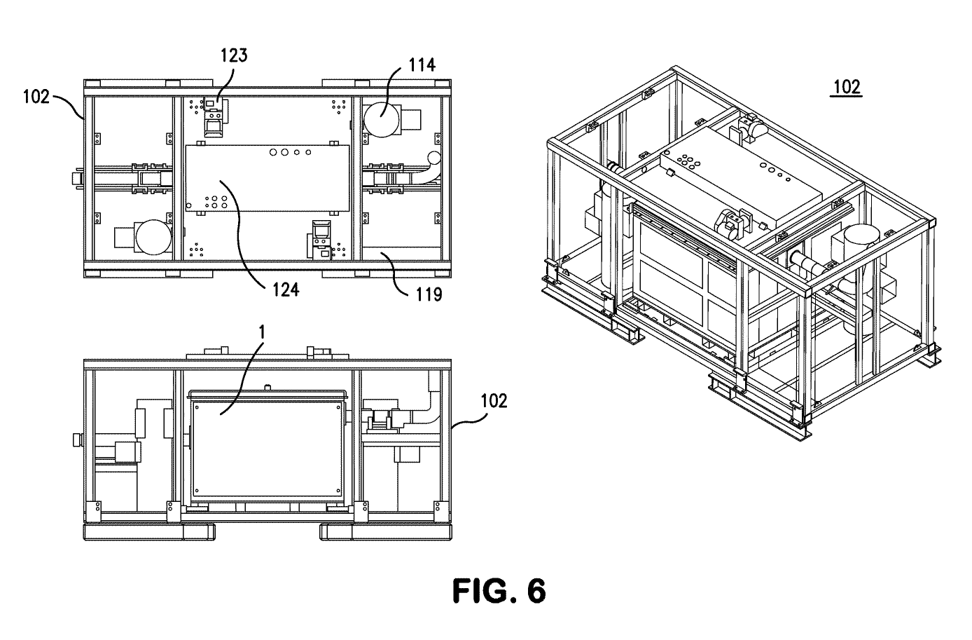

FIG. 6 is a top view and a side view for explaining the lower portion 102 of the skid structure 100 shown in FIG. 5, according to an example embodiment. As shown in FIG. 6, the lower portion 102 further includes an anchor winch 123 and a fuel tank 124. The anchor winch 123 is provided for each anchor silo/tube 114. The anchor winch 123 retracts and releases the anchoring mechanisms provided for each anchor silo/tube 114. The fuel tank 124 holds fuel to be provided to the generator in the generator housing 111.

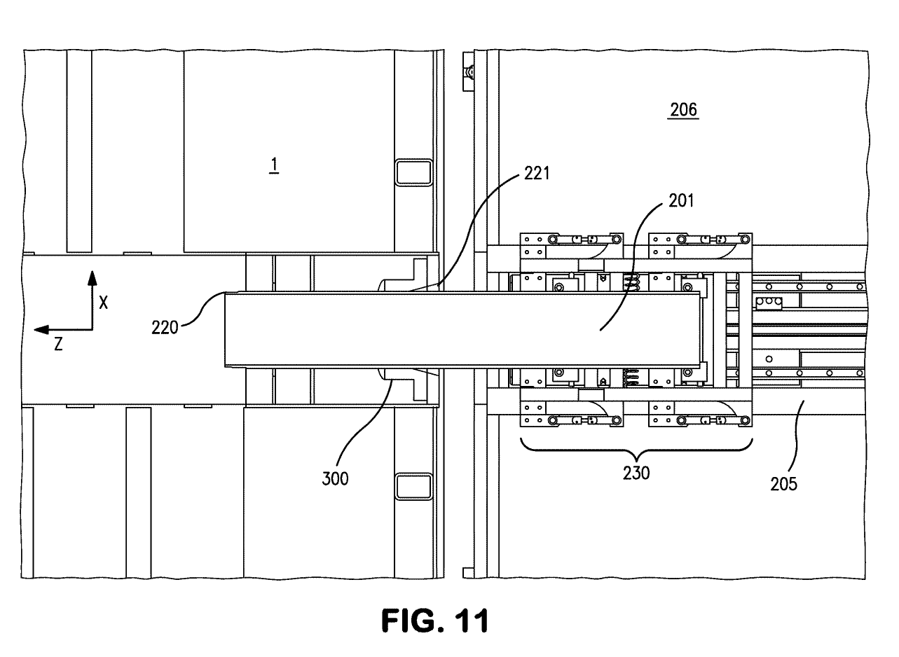

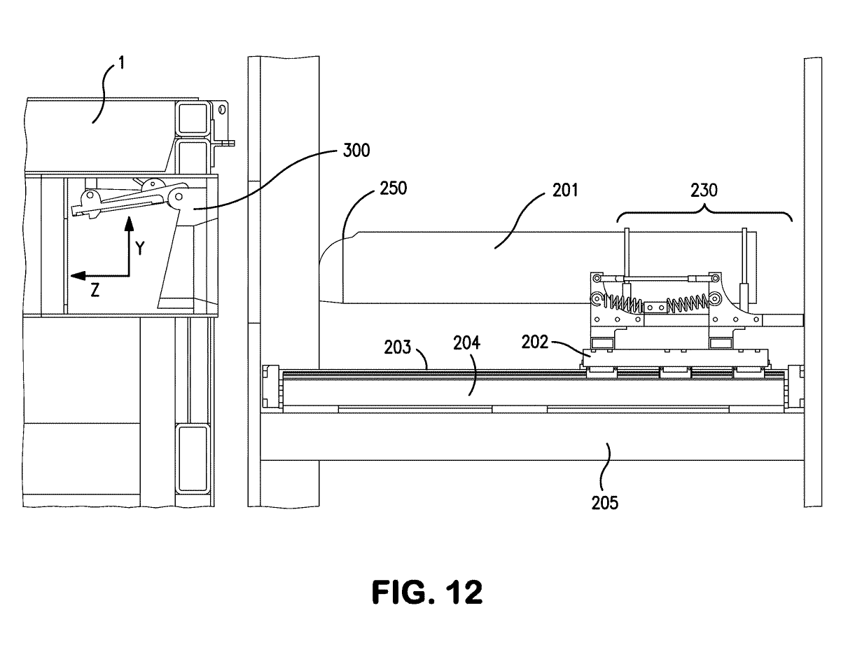

FIG. 7 is an isometric view for explaining the vacuum tube insertion mechanism 122 for inserting a vacuum tube into the waste container 1 according to an example embodiment. As shown in FIG. 7, the vacuum tube insertion mechanism 122 includes a vacuum tube 201, a slide 202, a pneumatic cylinder 203, and a set of rails 204. The vacuum tube 201 is connected to the slide 202. This connection is described in detail below in connection with FIGS. 11 and 12.

The pneumatic cylinder 203 uses the power of compressed gas to produce a force in a reciprocating linear motion to move the slide 202 along the set of rails 204. This in turn moves the vacuum tube in a linear motion in order to insert the vacuum tube 201 into the waste container 1.

FIG. 7 shows the vacuum tube insertion mechanism 122 in which the slide 202 together with the vacuum tube 201 are positioned at a starting point at one end of the set of rails 204 and pneumatic cylinder 203.

While the vacuum tube insertion mechanism 122 has been described for a single inlet penetration, it should be noted that multiple vacuum tube insertion mechanisms can be provided for multiple inlet penetrations. In addition, the disclosure of the vacuum tube insertion mechanism can also be applicable to inserting/withdrawing a tube into the outlet penetration of the container, in example embodiments that allow such.

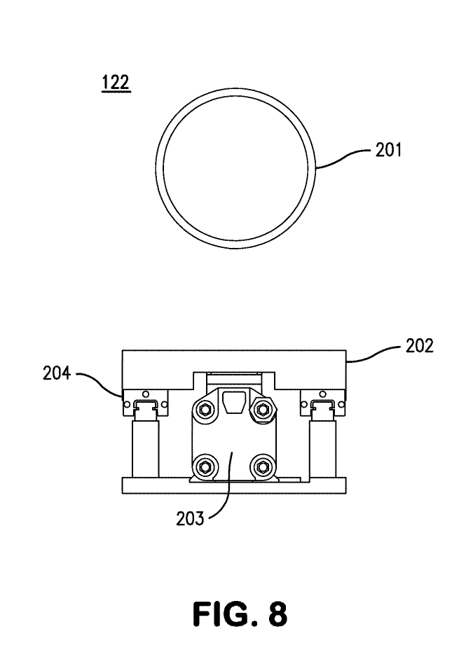

FIG. 8 is an axial view for explaining the mechanism shown in FIG. 7. As shown in FIG. 8, the slide 202 rests on the set of rails 204 via two U-shaped fittings. Moreover, the pneumatic cylinder 203 is connected to the slide 202 in order to move the slide.

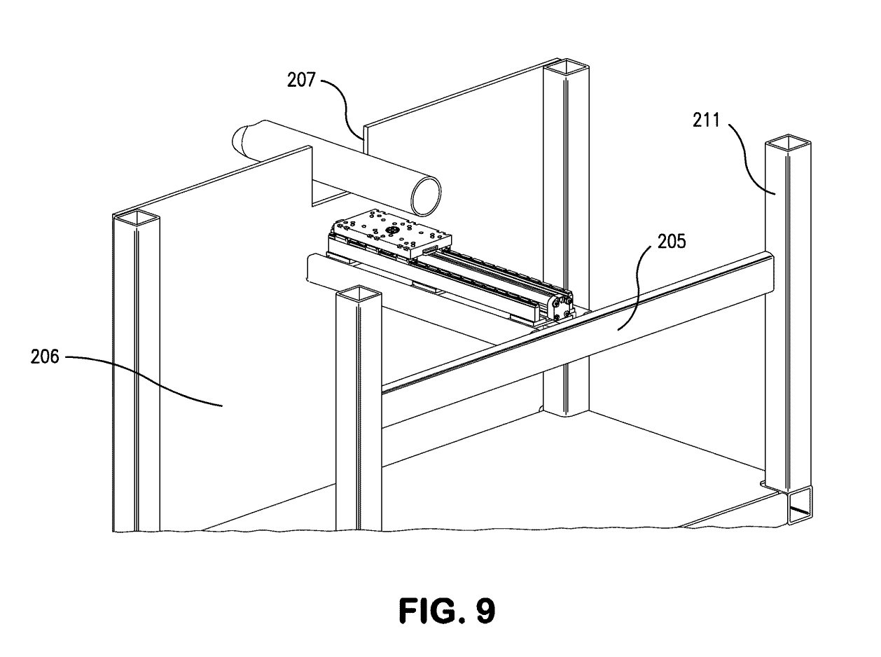

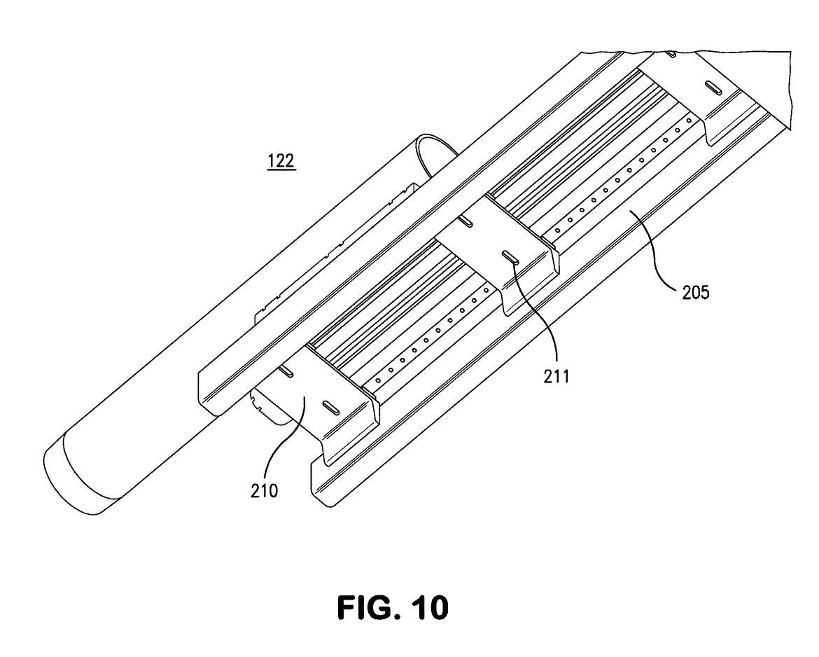

FIGS. 9 and 10 are isometric views for explaining the mechanism shown in FIG. 7 together with additional structure according to an example embodiment. As shown in FIG. 9, the vacuum tube insertion mechanism 122 is connected to a hollow structural section 205 for connecting the vacuum tube insertion mechanism 122 to a frame 211 of the skid structure 100. Connected to the frame 211 is a shield wall 206. Provided in the shield wall 206 is a cut-out 207 so that the vacuum tube 201 may insert into the waste container 1 which is provided on the other side of the shield wall 206. The cut-out 207 allows the vacuum tube 201 to pass thru the shield wall 206 within the frame. The shield wall 206 can protect serving technicians/workers from radiation exposure due to the radioactive waste inside the waste container 1.

As shown in FIG. 10, the vacuum tube insertion mechanism 122 can include one or more c-channel brackets 210 which are connected to the hollow structural section 205. Each c-channel bracket 210 includes one or more adjustable mounting points 211 which allow fine tuning during installation of the vacuum tube insertion mechanism 122.

FIG. 11 is a top view illustrating the vacuum tube insertion mechanism 122 shown in FIG. 7 for illustrating insertion of the vacuum tube 201 into the waste container 1 according to an example embodiment. As shown in FIG. 11, a chamfer 220 is provided around the end of the vacuum tube 201 to be inserted into the waste container 1 through an entry valve 300. In addition, a chamfer 221 is provided on the entry valve 300 on the side of the valve in which the vacuum tube 201 is to be inserted. The chamfer 220 may have, for example, a measurement of ⅛″ (3 mm), and the chamfer 221 may have, for example, a measurement of ⅝″ (16 mm). As further shown in FIG. 11, the vacuum tube 201 is connected to the slide 202 via a bracket 230. The bracket 230 is spring loaded such that the vacuum tube may move back and forth in the X or horizontal direction.

By providing the chamfer 220, the chamfer 221, and the spring loaded bracket 230, a tolerance is created when inserting the vacuum tube 201 into the entry valve 221 of the waste container 1 which can ensure consistent proper insertion of the vacuum tube.

In this example embodiment, the spring-loaded bracket 230 is provided to ease the trajectory of the vacuum tube insertion mechanism 122 into the respective port(s). However, in other example embodiments, a precision-machining approach is utilized to custom fit the waste container 1 in a position conducive to reliable and repeatable insertion into the waste container 1.

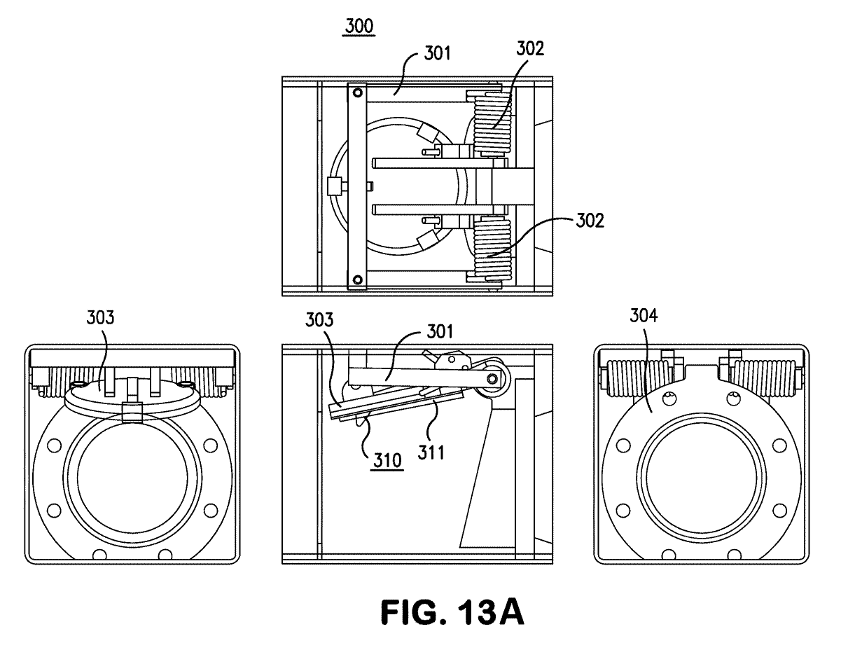

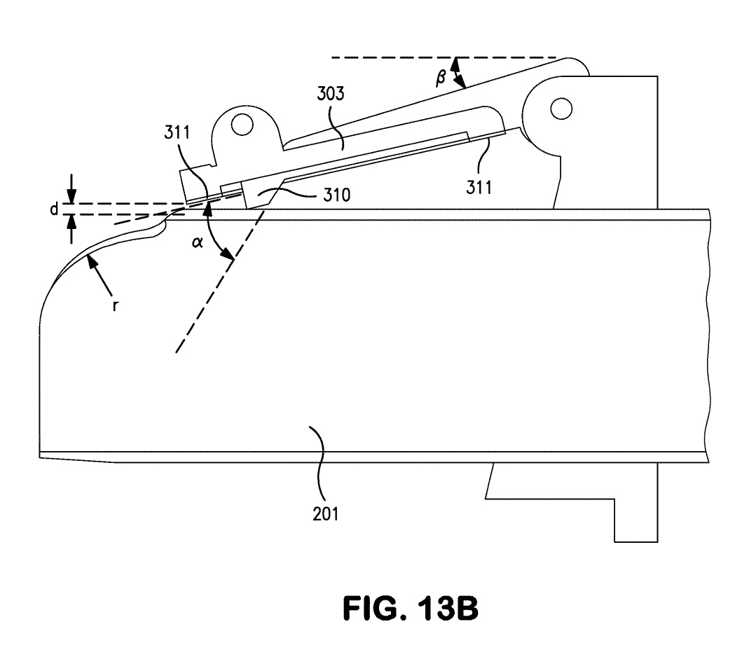

FIG. 12 is a side view for explaining the vacuum tube insertion mechanism 122 shown in FIG. 7 provided for illustrating insertion of the vacuum tube 201 into the container according to an example embodiment. As shown in FIG. 12, the bracket 230 is spring loaded such that the vacuum tube 201 may move in the Y or vertical direction when inserting the vacuum tube 201 into the waste container 1. In addition, the vacuum tube 201 is provided with a chamfer 250 at the end of the vacuum tube 201 to be inserted into the waste container 1. Again, by providing the spring-loaded bracket 230 and the chamfer 250, a tolerance is created when inserting the vacuum tube 201 into the entry valve 221 of the waste container 1 which can ensure consistent proper insertion of the vacuum tube. A further functionality of the chamfer 250 is discussed below in connection with FIGS. 13A and 13B.

FIG. 13A shows four views of an entry valve 300 for the waste container 1 shown in FIGS. 1 to 4, in which the valve is open according to an example embodiment. As shown in FIG. 13A, the entry valve 300 includes a bracket 301, two spring-loaded hinges 302, a flap door 303, and a body 304. The bracket 301 is used for mounting the entry valve 300 in an insert. The bracket 301 also serves the function of stopping the flap door 303 from making a rotation past 90 degrees. The spring-loaded hinges 301 provide a load on the flap door 303 such that the waste container 1 remains sealed when sufficient pressure is not being provided to open the entry valve 300. The body 304 is attached to the side of the waste container 1, by, for example, bolts. The flap door 303 opens inwards which typically allows only the vacuum tube to pass through. Once the vacuum tube 201 is removed from the entry valve 300, the force of the closure mechanism on the flap door 303 seals the waste container 1 and protects the environment from the inadvertent release of hazardous materials.

As further shown in FIG. 13A, the flap door 303 includes a protrusion 310 and a sealing surface 311. The protrusion 310 is provided on the side of the flap door 303 which faces outward from the waste container 1 when the entry valve 300 is closed. The sealing surface 311 is also provided on the side of the flap door 303 which faces outward from the waste container 1 when the entry valve 300 is closed. The sealing surface 311 can be, for example, a ⅛ inch thick annular ring made, for example, of neoprene rubber. The sealing surface 311 can be, for example, glued to the flap door 303.

FIG. 13B is a view illustrating the entry valve shown in FIG. 13A, in which a vacuum tube has entered the entry valve according to an example embodiment. As shown in FIG. 13B, the protrusion 310 is slanted at an angle α on the side of the protrusion facing the spring-loaded hinges 302. In this example embodiment, the angle α can be around 30 degrees. However, in other example embodiments, the angle α can be less than or greater than 30 degrees, based on, for example, a size or height of the sealing surface 311. Moreover, in this example embodiment, an angle β can be, for example, around 15 degrees while the protrusion 311 is in contact with the vacuum tube 201. Also, in this example embodiment, a contact angle between the flap door 303 and the chamfer 250 of the vacuum tube 201 can be, for example, around 45 degrees, and a radius “r” can be, for example, around 2.5 inches.

By providing the protrusion 310 on the flap door 303, a distance “d” is provided between the vacuum tube 201 and the flap door 303. This distance d is large enough to raise the seal material of the sealing surface 311 of the flap door 303 away from the surface of the vacuum tube 201 so as not to damage the sealing material during insertion and withdrawal of the vacuum tube 201.

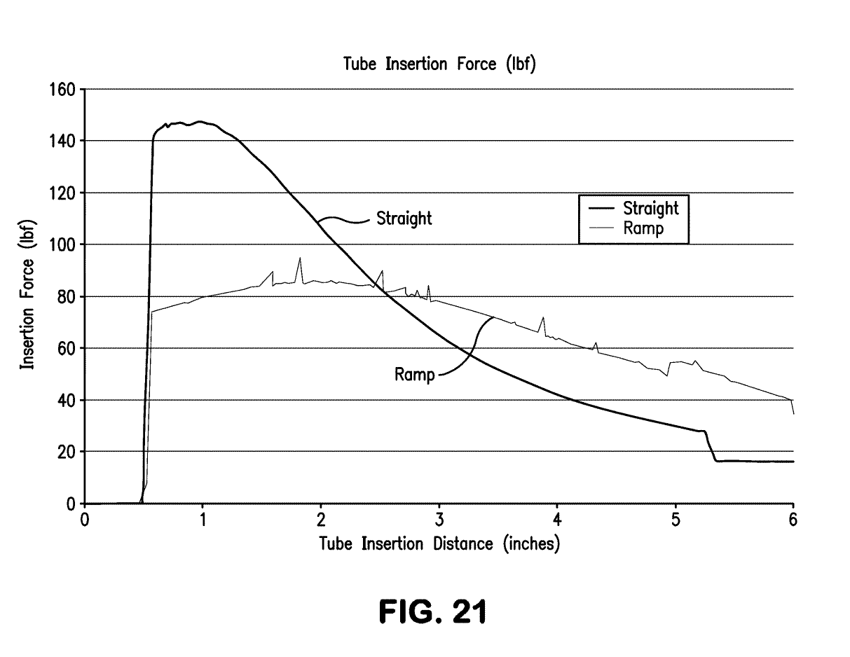

When the vacuum tube 201 is inserted in the entry valve 300, the vacuum tube slides through the entry valve 300 pushing the flap door 303 such that the flap door 303 opens and rotates inwards. Because of the chamfer 250, the vacuum tube 201 contacts the flap door 303 at a position closer to the edge of the door, providing a greater torque than if the vacuum tube 201 contacted the flap door 303 closer to the center of the door. As the flap door 303 opens, the vacuum tube 201 continues to apply pressure at the edge of the door because of the shape of the chamfer 250. Applying torque from the edge of the flap door 303 is especially beneficial when initially opening the flap door 303, since the flap door 303 is under a large amount of pressure when sealed. In other words, the rounded end of the vacuum created by the chamfer 250 requires a smaller initial force to open the flap door 303 than an initial force required by a straight tube to open the flap door 303. This is evidenced in FIG. 21.

FIG. 21 is a graph showing insertion force of the vacuum tube measured in lbf versus tube insertion distance of the vacuum tube measured in inches. As shown in FIG. 21, the initial force required for a straight tube to open the flap door 303 is greater than the initial force required for a rounded or ramped tube to open the flap door 303.

When the vacuum tube 201 is removed/withdrawn from the entry valve 300, the flap door 303 closes by the torque being provided by the spring-loaded hinges 302. When the vacuum tube 201 is inserted into the entry valve 300, the chamfered/cammed surface at the tip of the vacuum tube lowers the overall force required to open the flap, thus allowing a higher force spring to be used to achieve accordingly higher flap door closure forces, while mitigating the need to use a larger prime mover (e.g., cylinder) or high pressure hydraulic systems and actuators.

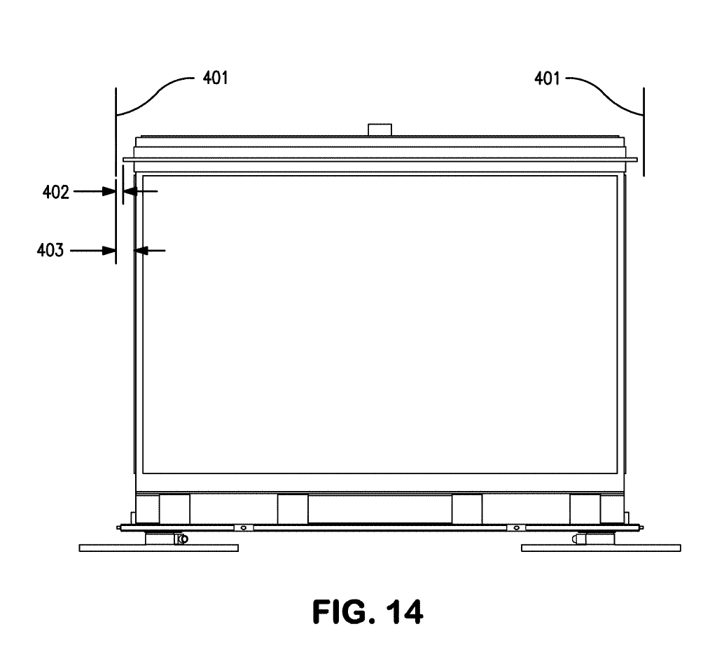

FIG. 14 is a side view for explaining the container shown in FIGS. 1 to 4, illustrating how the waste container 1 fits into the skid structure 100 shown in FIGS. 5 and 6 according to an example embodiment. As shown in FIG. 14, two bumpers 401 are provided on either side of the waste container 1 for the lid of the container. A clearance 402 can be, for example, around 1 inch, and a clearance 403 can be, for example, 3 inches. The bumpers 401 can be, for example, made up of plastic such as ultra-high-molecular-weight polyethylene (UHMW-PE).

FIG. 15 is an isometric view illustrating a cut-out of the lower portion of the skid structure shown in FIG. 6 according to an example embodiment. This view of the lower portion 102 of the skid structure 100 is shown without a container plate. As shown in FIG. 15, the lower portion 102 includes at least one load cell 501. The load cell serves the function of weighing the waste in real time as it accumulates inside the waste container 1. This allows another form of fill detection external to the waste container 1.

FIG. 16 is a plan view for explaining a load cell arrangement included in the lower portion 102 of the skid structure 100 shown in FIGS. 5 and 6 according to an example embodiment. In this example embodiment, four load cells 501 are positioned in each corner below where the waste container 1 will sit.

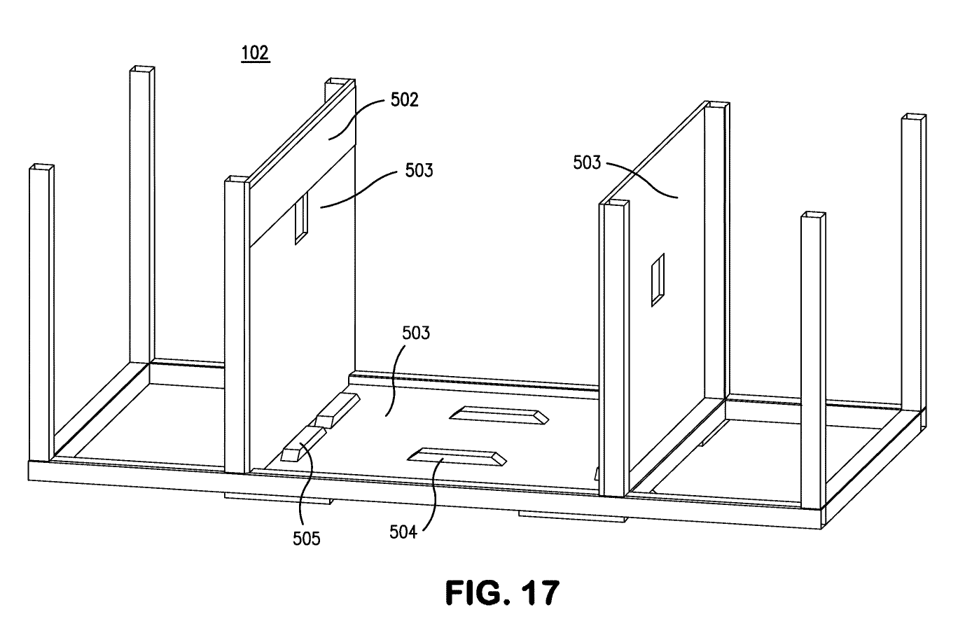

FIG. 17 is an isometric view showing a cut-out of the lower portion 102 of the skid structure 100 shown in FIG. 6, including a container plate 503 according to an example embodiment. The container plate 503 serves as a primary guidance and positioning device for the waste container 1 to receive the vacuum tubes. In this regard, in this example embodiment, the container plate 503 includes guide shoes 504 and 505. The guide shoes 504 and 505 are positioned on the container plate 503 in such a manner as to accurately place the apertures for the vacuum tubes in proper alignment for a clear trajectory. As also shown in FIG. 17, included in the skid structure 100 are plastic bumpers 502 for the lid of the waste container 1.

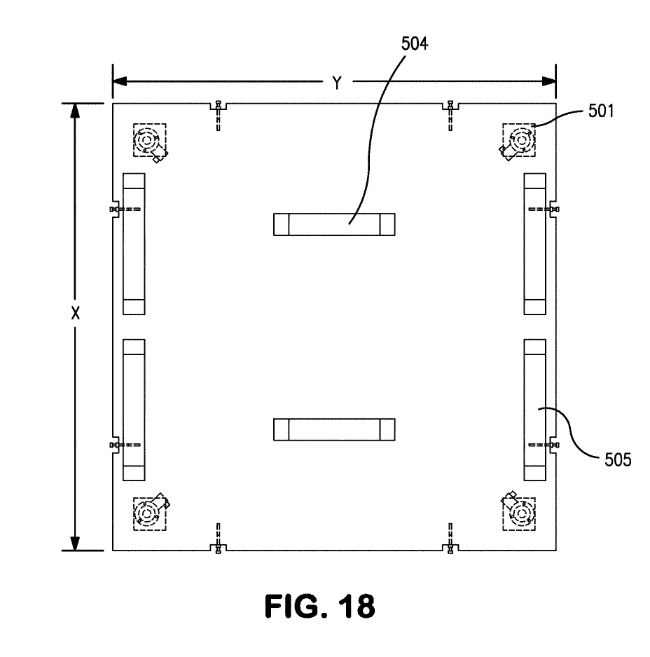

FIG. 18 is a plan view for explaining the container plate shown in FIG. 17 according to an example embodiment. FIG. 18 shows the guide shoes 504 positioned in the center of the container plate 503 parallel to the side Y, and shows the guide shoes 505 at the edges of the container plate 503 parallel to the side X. This positioning of the guide shoes 504 and 505 can provide accurate placement of the apertures of the waste container 1 for the vacuum tube 201 in proper alignment for a clear trajectory.

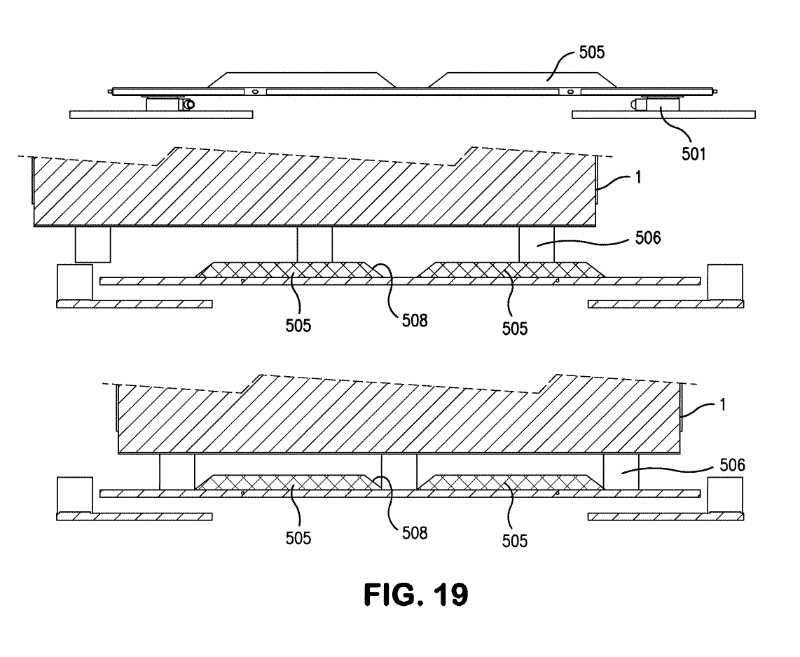

FIG. 19 is a side view for illustrating insertion of the container shown in FIGS. 1 to 4 into the skid structure 100 shown in FIGS. 5 and 6 according to an example embodiment. In particular, FIG. 19 shows a process of inserting the waste container into the skid structure 100. In this example embodiment, three lift slots 506 are provided at the bottom of the waste container 1. As shown in FIG. 19, the waste container 1 is pushed across the guide shoes until a middle one of the three lift slots 506 sits snugly between the guide shoes 505, and the outer lift slots fit tightly along the sides of the guide shoes 505.

As shown in FIG. 19, a clearance is provided between the guide shoes 505. This clearance is provided so that the waste container 1 can be pulled tightly against a flat edge 508 after the waster container 1 is dropped-in or placed inside the skid structure 100. More specifically, the flat edge 508 is about perpendicular to the bottom surface of the skid structure 100 such that the lift slot 506 can abut the flat edge 508. This can provide a known reference/indexing surface for accurate and repeatable alignment of the waste container 1.

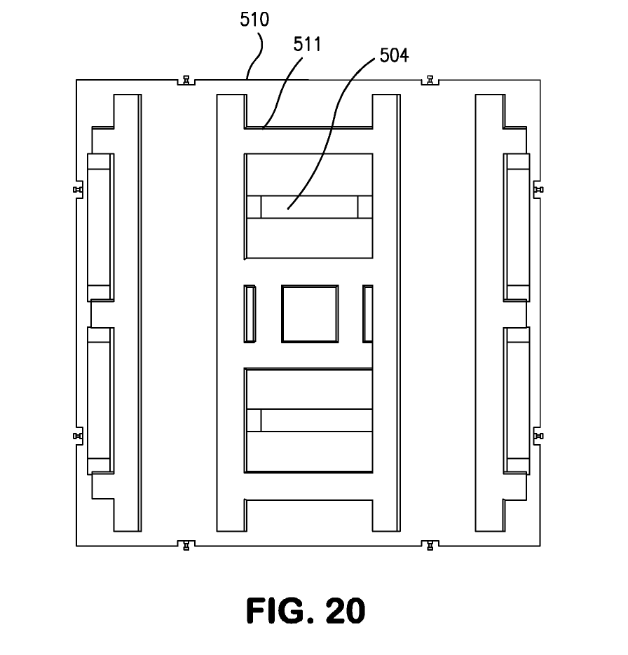

FIG. 20 is a plan view of a container base according to an example embodiment. More specifically, FIG. 20 shows a base 511 of the waste container 1 fitting within the guide shoes. As discussed above, the waste container 1 is placed in the skid structure 100 such that the waste container 1 is provided with a known reference/indexing surface for accurate and repeatable alignment of the waste container 1.

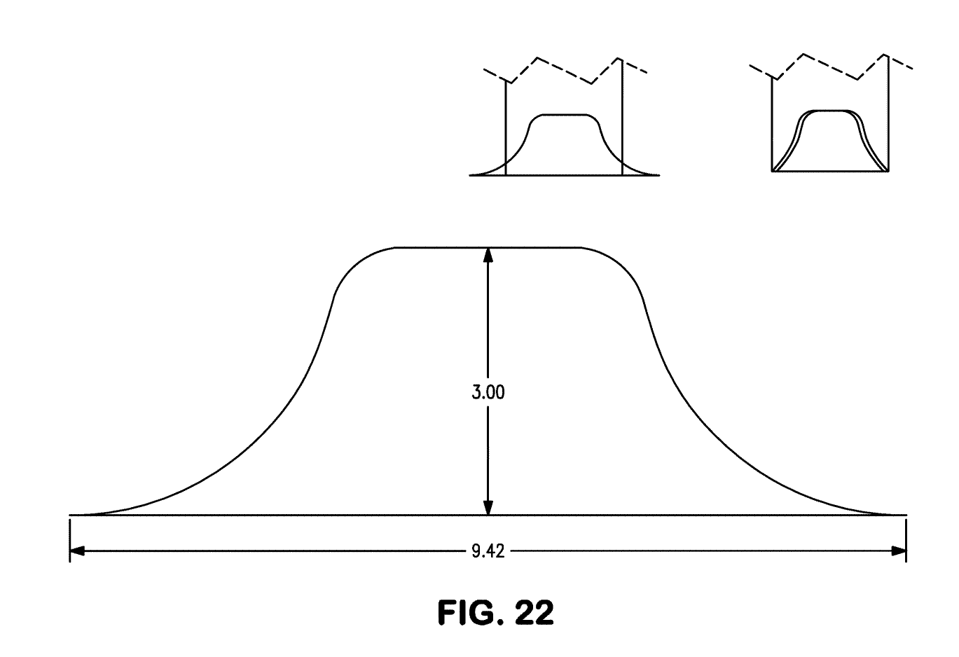

FIG. 22 is a diagram for illustrating a detailed cam profile of the chamfer manufactured into the piercing end of the vacuum tube 201. In particular, FIG. 22 shows an example shape and size of a template/stencil used for manual fabrication of the chamfer 250 using a blow torch, according to an example embodiment. In addition, FIG. 22 shows wrapping of a template/stencil around the vacuum tube 201 to create the chamfer 250, according to an example embodiment.

While various example embodiments of the present invention have been described above, it should be understood that they have been presented by way of example, and not limitation. It will be apparent to persons skilled in the relevant art(s) that various changes in form and detail can be made therein. Thus, the present invention should not be limited by any of the above described example embodiments, but should be defined only in accordance with the following claims and their equivalents.

In addition, it should be understood that FIGS. 1 to 22 are presented for example purposes only. The architecture of the example embodiments presented herein is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that any procedures recited in the claims need not be performed in the order presented.

What is claimed is:

1. A container for collecting and filtering material, comprising:
an inlet penetration through at least one surface of the container;
an outlet penetration through at least one surface of the container; and
at least one filter being integral to the container such that the at least one filter is disposed of together with the container, the at least one filter being connected to the outlet,
wherein the material enters the container through the inlet, the material conveyed by a media is passed through the at least one filter resulting in a clean media stream, and the clean media exits the container through the outlet.

2. The container according to claim 1, further comprising a status monitor that monitors the status of the container,
wherein the material is collected by the container until the status monitor requests that collection be stopped.

3. The container according to claim 2, wherein the status monitor comprises a weight alarm that measures a weight of the container, and requests that collection be stopped when the container reaches a predetermined weight.

4. The container according to claim 2, wherein the status monitor comprises an internal level indicator that measures a filled volume of the container, and requests that collection be stopped when a material collected reaches a predetermined height within the container.

5. The container according to claim 2, wherein the status monitor comprises a chemical sensor that detects concentrations of chemicals, and requests that collection be stopped when a predetermined concentration of a predetermined chemical has been reached.

6. The container according to claim 1, wherein the at least one filter is self-cleaning.

7. The container according to claim 6, wherein the at least one filter is self-cleaning by periodically blowing compressed air into the at least one filter, such that filtration is performed inside the container until the container is full of material.

8. The container according to claim 7, wherein the container comprises at least two filters, and a first one of the at least two filters is cleaned by a pulse of air while a second one of the at least two filters is filtering, and the second one of the at least two filters is cleaned by a pulse of air while the first one of the at least two filters is filtering.

9. The container according to claim 1, further comprising a plenum,
wherein the plenum is connected to the outlet penetration, and the at least one filter is connected externally to the plenum.

10. The container according to claim 9, further comprising a lid,
wherein the plenum is integrated with the lid such that it serves as a structural element to reinforce the container against stresses.

11. The container according to claim 1, further comprising a differential pressure gage to detect a pressure differential across the at least one filter.

12. The container according to claim 1, further comprising a differential pressure gage to detect a pressure difference between an outside and an inside of the container.

13. The container according to claim 1, further comprising a vent or a drain,
wherein the vent or the drain releases buildup of pressure or fluids in the container.

14. The container according to claim 1, further comprising one or more inspection ports for inspecting inside of the container.

15. The container according to claim 1, further comprising at least one baffle inside of the container to protect the at least one filter from being damaged.

16. The container according to claim 1, wherein the inlet penetration or outlet penetration comprises:
an entry valve including a flap door,
wherein a protrusion is provided on a surface of the flap door, the surface facing outside the container.

17. The container according to claim 1, wherein the material enters the container through the inlet and the clean media exits the container through the outlet, by creating a vacuum source.

18. The container according to claim 1, wherein the material enters the container through the inlet and the clean media exits the container through the outlet, by pressurizing the container.

19. A skid structure comprising:
the container according to claim 1; and
a container plate for supporting the container, the container plate including at least one load cell for weighing the container.
